(19) United States
(12) Patent Application Publication
(10) Pub. No.: US 2025/0116565 A1
(43) Pub. Date: Apr. 10, 2025

(54) VACUUM GRIPPER, METHOD OF DETECTING LEAKAGE INTO THE GRIPPER AND AUTOMATED GRIPPER AND USE THEREOF

(71) Applicant: PIAB AKTIEBOLAG, DANDERYD (SE)

(72) Inventors: Anders FALK, TÄBY (SE); Andreas NORDSTRÖM, SOLLENTUNA (SE)

(21) Appl. No.: 18/729,834

(22) PCT Filed: Dec. 13, 2022
(86) PCT No.: PCT/EP2022/085629

§ 371 Date: Jul. 17, 2024

(30) Foreign Application Priority Data
Jan. 18, 2022 (EP) 22152021.6

(51) Int. Cl. G01M 3/26; B25J 15/06

(52) U.S. Cl. CPC G01M 3/26; B25J 15/0616

(57) ABSTRACT

A vacuum gripper having a suction area with improved leakage detection, a method of detecting leakage of surrounding fluid into such vacuum gripper, a method of detecting leakage of surrounding fluid into a gripper, and an automated operation involving engaging a sheet-formed object with the vacuum gripper are disclosed.

### FIELD OF THE INVENTION

The present invention relates to a vacuum gripper, and more particularly a vacuum gripper having a suction area with enhanced leakage detection, a method of detecting leakage of surrounding fluid into such vacuum gripper, and use of the vacuum gripper in an automated process involving engaging a sheet-formed object with the vacuum gripper, such as e.g. a stacking operation.

### BACKGROUND ART

Suction grippers, also referred to as vacuum grippers, are known in the art, and are e.g. conventionally used for lifting sheet-formed objects having an essentially planar surface. One type of suction gripper comprises a housing having an internal vacuum chamber connected to a source vacuum, and a number of suction holes in a suction area thereof to be engaged with an object to be handled, which holes stand in fluid connection with the vacuum chamber inside the gripper.

A problem may arise when the object to be engaged by the gripper is not appropriately aligned with the suction surface of the gripper. In such instances, especially in automated operations, the object may be released, such as stacked onto a previously released object, in an unintended orientation. Another problem may arise when a portion or area of the object to be engaged by the gripper is creased or folded. This may e.g. lead to an uneven stacking and/or undesired interstices in the resulting stack.

It would be desirable to be able to detect an incorrect alignment of the object, or a creased or folded area of the object.

It is an object of the present invention to provide a vacuum gripper overcoming either one, or both, of the above problems.

### SUMMARY OF THE INVENTION

According to the present invention, for a vacuum gripper 10 for gripping sheet-formed objects 100 of the preamble of claim 1, comprising a body 20 having: an internal primary vacuum chamber 25; an opening 15 for connecting the internal primary vacuum chamber 25 to a source of vacuum 17; an opening 30 for connection to a pressure sensor 33 configured to sensing a pressure inside the gripper body 20; a suction area A2, A1 for engaging a sheet-formed object 100; and, at least one suction hole 3 provided in the suction area A1, A2; the above object has been achieved by means of the characterizing features according to which the body 20 additionally comprises a secondary internal vacuum chamber 35 which stands in fluid communication with the internal primary vacuum chamber 25 via a flow-restriction 37, and in that said at least one suction hole 3 is provided in a suction area A2 of the secondary internal vacuum chamber 35, wherein the size of the cross-sectional area of the flow restriction 37 is similar to the size of the cross-sectional area of one hole of the at least one hole 3, and the opening 30 for connection to a pressure sensor 33 is provided in the secondary internal vacuum chamber 35. Accordingly, the pressure sensor 33 is configured to sensing a pressure inside a secondary internal vacuum chamber 35 of gripper body 20.

Accordingly, in one aspect the invention relates to a vacuum gripper as set forth above.

In another aspect, the invention relates to a method of detecting leakage of surrounding fluid into a vacuum gripper 10 for gripping sheet-formed objects 100, comprising the steps of: engaging a sheet-formed object 100 with a vacuum gripper 10; while the sheet-formed object 100 is engaged with the vacuum gripper 10, monitoring a pressure in an internal vacuum chamber 35 of the gripper 10 using a pressure sensor 33 connected to the internal vacuum chamber 35; comparing the monitored pressure with a pre-determined desired pressure; and, establishing a monitored pressure which is higher than a pre-determined acceptable maximum pressure, wherein the gripper 10 comprises a primary internal vacuum chamber 25, and a secondary internal vacuum chamber 35, which chambers are fluidly connected to each other via a flow-restriction 37, and in that the pressure which is monitored is the pressure in the secondary internal vacuum chamber 35.

In a preferred embodiment, the inventive method is discontinued when a monitored pressure in the secondary internal vacuum chamber 35 of the gripper 10 is established to be higher than the pre-determined acceptable maximum pressure.

The inventive method and the inventive vacuum gripper can preferably be used in an automated operation involving engaging a sheet-formed object 100, such as for stacking a number of sheet-formed objects 100 on top of each other.

Further embodiments and advantages of the invention will be apparent from the following detailed description and appended claims.

The term “flow-restriction”, as used herein, is intended to refer to an open passage fluidly connecting the primary vacuum chamber 25 with a secondary vacuum chamber 35. In order to fluidly connect the primary vacuum chamber 25 with a secondary vacuum chamber 35, the open passage should be open at all times and should not comprise any movable parts, such as for closing the passage.

### BRIEF DESCRIPTION OF THE ATTACHED DRAWINGS

FIG. 1 shows an embodiment of a gripper 10 according to the invention comprising a gripper body 20 having a suction area A1, A2. As will be shown in FIG. 3A, the gripper of FIG. 1 has a primary vacuum chamber 25 provided with a multitude of suction holes 3, and two secondary vacuum chambers 35 each of which are provided with a multitude of suction holes 3. The gripper shown in FIG. 1 also comprises an ejector 17, and two openings 30 for connection to a pressure sensor 33. In FIG. 1, only one connection and pressure sensor 33 is shown, the other connection and pressure sensor 33 has been removed for illustration purposes. FIG. 1 also shows a compressible foam sheet 50 having a multitude of holes 53 and a non-permeable adhesive backing 65, which sheet can be attached to the suction area A1, A2 of the gripper 10, a stiffening sheet 60 having a multitude of holes 63, which sheet can be attached to the compressible foam sheet 50, and a sheet-formed object 100, having two sensitive portions 70, to be engaged by the gripper.

FIG. 2 shows the gripper body 20 of gripper 10 in FIG. 1 having an opening 15 which is connected to the ejector 17 in the gripper of FIG. 1.

FIG. 3A shows a view along the section A-A of the gripper body 20 in FIG. 2 wherein the primary vacuum chamber 25 provided with a multitude of suction holes 3, and the two secondary vacuum chambers 35 each of which are provided with a multitude of suction holes 3 can be seen. Opening 15 shown in FIG. 2 enters into the primary vacuum chamber 25, and openings 30 shown in FIG. 2 enter into the respective secondary vacuum chambers 35.

FIG. 3B shows a sectional view along the section B-B of the gripper body 20 shown in FIG. 3A. The fluid flow through flow restriction 37, and holes 39 and flow passage 38, respectively, during evacuation of the two secondary chambers 35 is indicated by arrows in FIG. 3B.

FIG. 4 is a bottom view of gripper body 20 shown in FIG. 2 showing the suction area A1, A2. FIG. 4 also shows a detailed view C of openings 39 and flow passage 38, wherein the fluid flow through holes 39 via flow passage 38, during evacuation of the associated secondary chambers 35, is indicated by a solid arrow in the view along section B-B.

FIG. 5 shows a view along the section C-C of gripper body 20 in FIG. 4, and a detailed view D, wherein the fluid flow during evacuation of the left secondary chamber 35 in FIG. 5 is illustrated by the solid arrow.

FIG. 6 is a perspective view from below of gripper body 20, compressible foam sheet 50, and stiffening sheet 60.

FIG. 7 shows a bottom view of a gripper 10 having engaged an object 100, wherein a sensitive portion 70 of the object has been folded so as to not cover one of the holes 63 provided in the stiffening sheet 60, which hole 63 is aligned with a corresponding hole 3 provided in the underlying suction area A2 of the gripper body. Surrounding fluid will flow from the non-covered hole 63 in the stiffening sheet 60, and from hole 63 further into a corresponding underlying hole 53 in the foam sheet 50, and from hole 53 further into underlying hole 3 in the suction area A2 of the gripper body, and thereby enter into the secondary vacuum chamber 35 in which chamber said hole 3 is provided.

### DETAILED DESCRIPTION OF THE INVENTION

The present invention is based on separating a secondary vacuum chamber 35 from a primary vacuum chamber 25 in a vacuum gripper 10, and restricting fluid communication between the respective two separated vacuum chambers by means of a flow restriction 37, wherein the primary vacuum chamber is connected to a source of vacuum. Fluid communication between a secondary vacuum chamber 35 and the primary vacuum chamber 25 is restricted to communication via flow restriction 37. The suction area A2, corresponding to the secondary vacuum chamber, exhibits one or more suction holes 3. By appropriate selection of the cross-sectional area of the flow restriction, the pressure in the secondary vacuum chamber 35 during operation of the gripper will be markedly higher than the pressure in the primary vacuum chamber when merely a single suction hole 3 of a suction area A2 is not covered by an engaged object 100. A pressure sensor 33 connected to the secondary vacuum chamber 35 configured to sensing a pressure inside said chamber will sense the higher pressure in the secondary vacuum chamber 35. It is believed that the cross-sectional area of the flow restriction will generally be within the range of ±50%, typically ±25%, preferably ±10% of the cross-sectional area of one hole of the at least one hole 3.

The inventive suction area A2 is preferably used for contacting and engaging with a sensitive portion 70 of an object 100, such as a portion which is amenable to enhanced flexing during handling of the object. An object 100 may exhibit more than one such sensitive portions 70. Accordingly, in one embodiment the inventive gripper exhibits more than one suction areas A2, each such additional suction area A2 corresponding to an additional secondary vacuum chamber 35, communicating with the primary vacuum chamber 25 via a corresponding additional flow restriction 37.

In one embodiment of the inventive gripper 10 the primary vacuum chamber 25 exhibits one or more suction holes 3 in a suction area A1. In such embodiments the suction area A1 will typically provide a major part of the suction power to the gripper. Accordingly, in such embodiments the suction area A1 will often be larger than the suction area A2. Also, in such embodiments, the cross-sectional area of a suction hole 3 provided in suction area A2 will typically be smaller than the cross-sectional area of a suction hole 3 provided in suction area A1.

In an alternative embodiment, the primary vacuum chamber 25 of a gripper 10 does not exhibit a suction hole 3, instead the primary vacuum chamber, to which chamber a source of vacuum 17 is connected, only stands in fluid connection with a number of secondary vacuum chambers 35 via a corresponding number of flow restrictions 37. In such embodiments the suction area of the gripper only comprises a number of suction areas A2, corresponding to the number of secondary vacuum chambers 35.

While in principle more than one flow restriction 37 could be provided for a given internal secondary vacuum chamber 35, for i.a. a more reliable operation and for a better sensitivity to detection of leakage, it is preferred that merely one flow restriction 37 is provided for each one internal secondary vacuum chamber 35.

The number of internal secondary vacuum chambers 35 is in principle not limited as long as the overall volume thereof is not too large in comparison to that of the primary vacuum chamber 25, and the number of pressure sensors can be kept reasonably low. For example, a number of internal secondary vacuum chambers 35 within the range of 1-10, such as 2, 3, 4, 5, 6, 7, 8 or 9 chambers, is conceivable. Generally, embodiments having 1, 2 or 3 internal secondary vacuum chambers 35 will be preferred.

For each internal secondary vacuum chamber 35, a pressure sensor 33 is provided for sensing the pressure in said internal secondary vacuum chamber. While more than one pressure sensor 33 could be provided for any given internal secondary vacuum chamber, e.g. for redundancy, it is preferred that merely one pressure sensor is provided for each internal secondary vacuum chamber 35 for a reduced complexity of the inventive vacuum gripper 10.

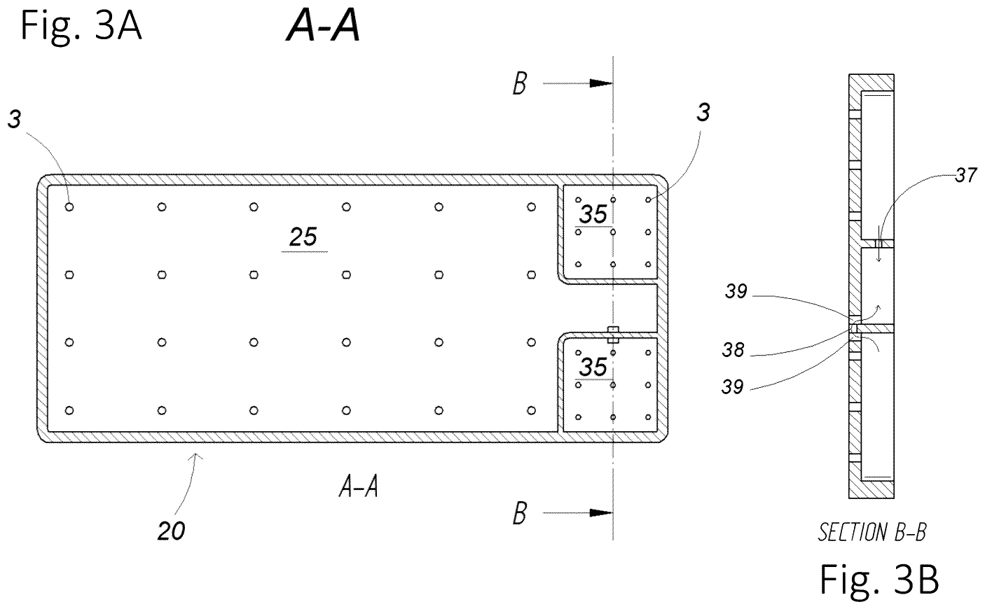

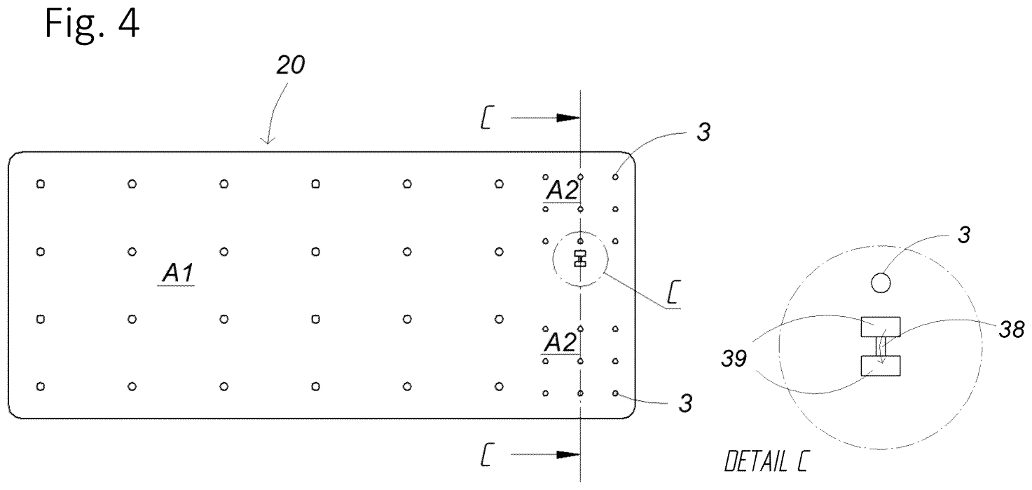

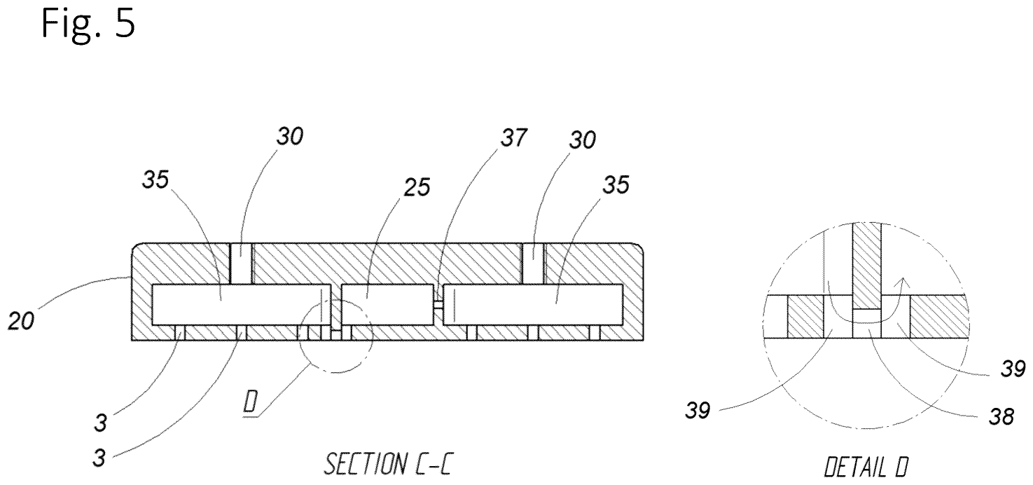

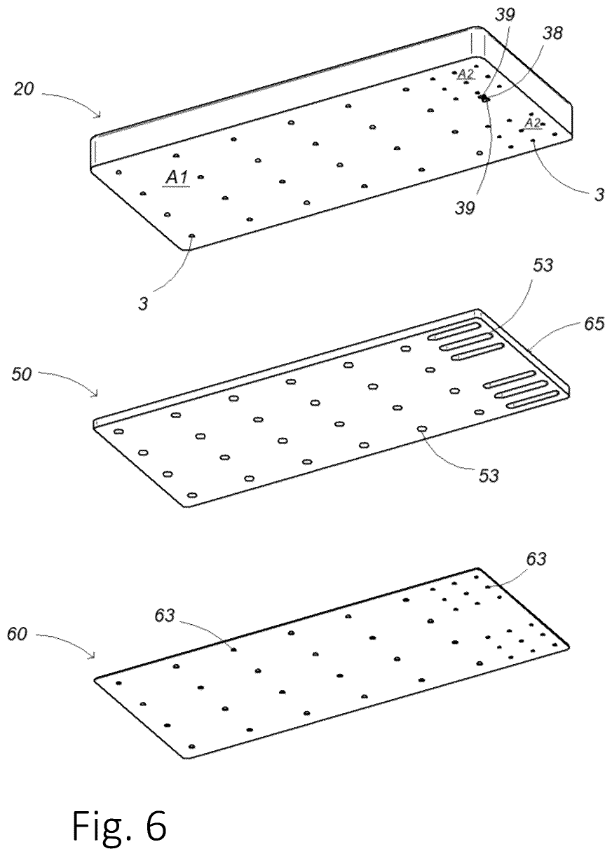

In a preferred embodiment the gripper exhibits a flow passage 38 which stands in fluid communication with a secondary internal vacuum chamber 35 and with the primary vacuum chamber 25. The flow passage has two openings 39 provided in the surface of the suction area of the gripper, one of which openings 39 enters into the secondary internal chamber 35, and the other of which openings 39 enters into the primary vacuum chamber 25. Upon closure of the openings 39 and flow passage 38 by a means for closure, a flow restriction 37 will be formed comprising the flow passage 38 and the means for closure. Closure of openings 39 can be accomplished by means of e.g. an adhesive sheet having an impermeable portion capable of being arranged so that the impermeable portion covers openings 39. Such flow passage 38 and holes 39 are illustrated in more detail in FIGS. 3, 4 and 5. Such embodiment having flow passage 38 and holes 39 is especially suited for being produced by additive manufacturing. Also, such embodiment allows for improved ease of subsequent adjustment of the flow restriction 37, such as merely by enlarging the flow passage 38, and possibly also holes 39. Also, such restriction 37 allows for an improved ease of inspection and clearing, e.g. for possible fouling or clogging thereof, by merely by removing the means for closure and inspecting flow passage 38 and holes 39. Flow passage 38 could comprise one or more replaceable sections (not shown), allowing for adjusting the cross-sectional area of the passage 38 merely by replacing one or more sections thereof with another section having a certain smaller or larger cross-sectional area.

A non-permeable adhesive sheet 65 can be used as a means for closure for closing off desired holes 3 in the suction surface, e.g. in order to modify the pattern of suction holes 3 provided in the overall suction area of the gripper, such as for adapting the gripper for engaging a slightly differently shaped object, and/or for closing off one or more openings 39 provided in the surface of the suction area of the gripper. As will be understood, such sheet will exhibit openings corresponding to desired active holes 3 of the gripper.

A compressible foam sheet 50 can be used with the gripper, e.g. in order to provide for a certain limited degree of flexibility of the gripper, such as for providing tolerance to small non-parallel imperfections in horizontal alignment of the gripper with a horizontally orientated object to be handled, and/or for providing a more gentle, pliable, compliant contact with an object 100, such as when a generally sensitive object 100, and/or an object 100 having a sensitive surface, is to be handled by the gripper 10. For an improved ease of attachment and replacement of the foam sheet 50, said sheet is preferably provided with an adhesive layer. The adhesive layer is preferably provided on an impermeable backing 65 of foam sheet 50. The impermeable backing 65 of foam sheet 50 may preferably function as the adhesive sheet described above. The foam sheet 50 exhibits one or more holes 53 corresponding to one or more holes 3 of the suction area A2 of the secondary internal vacuum chamber 35. Also, when a suction area A1 is present, the foam sheet 50 exhibits one or more holes 53 corresponding to one or more holes 3 of the suction area A1 of the primary internal vacuum chamber 35. The material of the foam of the compressible foam sheet is not critical. A suitable material is e.g. an ethylene propylene rubber, such as EPDM. The thickness and material of the foam sheet 50 should be selected so as to be capable of being substantially compressed when engaging an object 100.

With the compressible foam sheet 50 a stiffening sheet 60 is preferably used. The stiffening sheet should essentially cover the foam sheet. The stiffening sheet exhibits one or more holes 63 corresponding to holes 3 of the suction area A2 of the secondary internal vacuum chamber 35. Preferably, the stiffening sheet is attached to the foam sheet 50 by means of an adhesive layer, e.g. so as to be replaceable. The material of the stiffening sheet 60 is not critical, and can be chosen so as to be compatible with material of the object to be handled. As an example, a generally suitable material for the stiffening sheet is polycarbonate (PC).

The stiffening sheet 60 can also be used for closing off desired suction holes 3 and corresponding holes 53 in a suction area A2. Thereby, by replacing one stiffening sheet 60 with another stiffening sheet 60 closing off other desired suction holes 3 and corresponding holes 53 in a suction area A2, the inventive gripper can conveniently be adapted for gripping objects having a slightly different geometry, and/or having a different location of a sensitive portion 70.

In a preferred embodiment, the gripper body 20 exhibits a raised periphery (not shown) around the suction area A1, A2, raised guiding elements (not shown) along the periphery of the suction area A1, A2, or the suction area A1, A2 may be accommodated in a recess (not shown) in the bottom of gripper body 20 for accommodating in said recess a compressible foam sheet 50 and stiffening sheet 60. Such raised periphery, raised guiding elements, or recess, may provide for an improved ease of alignment of a compressible foam sheet 50 and stiffening sheet 60 to the gripper body 20.

In principle, more than one flow restriction 37 to a given single secondary internal vacuum chamber 35 could be used. However, such embodiment is not preferred.

The inventive vacuum gripper 10 preferably only has one point of vacuum connection 15.

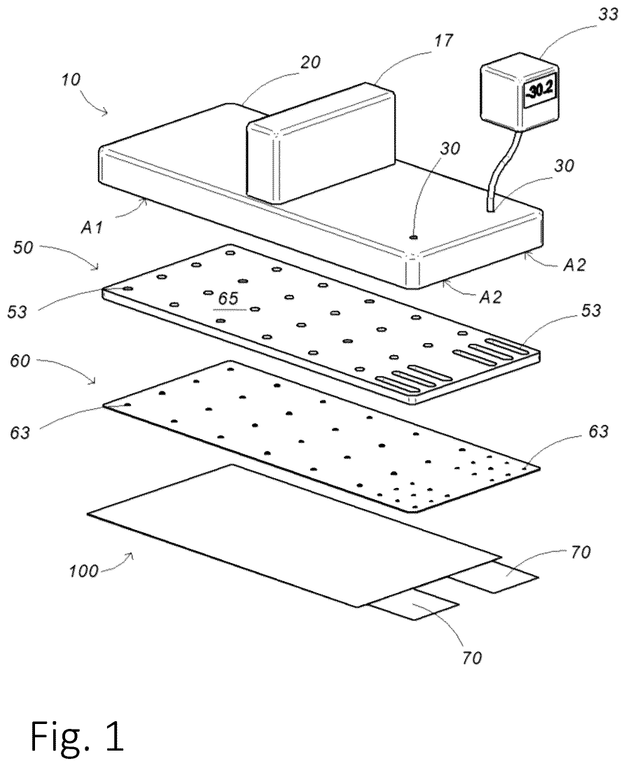

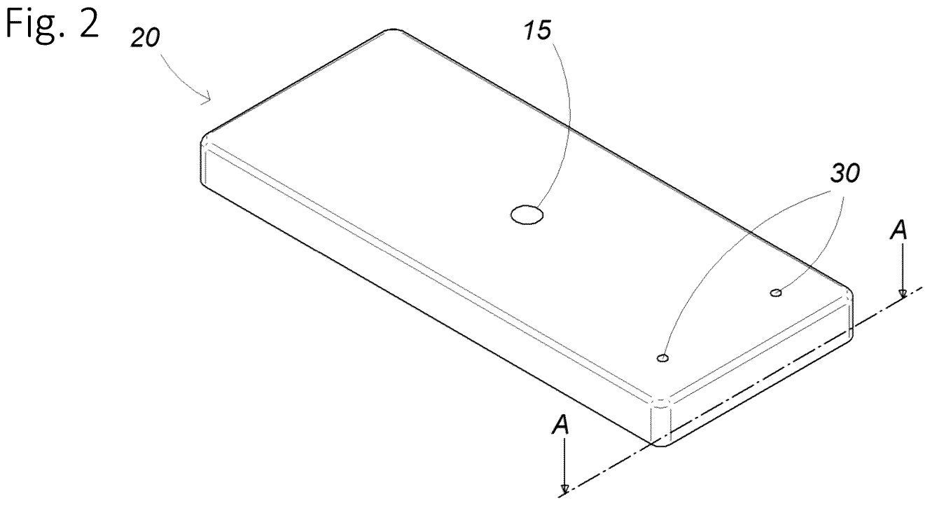

As a source of vacuum 17, an ejector is preferably used, such as shown in FIG. 1. When an ejector is used as a source of vacuum, such ejector is preferably attached to the gripper 10, such as to gripper body 20. By virtue of using a decentralised source of vacuum, such as an injector, onset and offset of vacuum to the gripper can be accomplished much quicker as compared to when a central source of vacuum is being used. Also, by using a decentralised source of vacuum close to the gripper, the volume to be evacuated will be reduced, since essentially no vacuum tubing will be required.

In a preferred embodiment the pressure sensor 33 takes the form of a vacuum switch, such as shown in FIG. 1. The vacuum switch is preferably configured to providing a signal when the pressure in the secondary internal vacuum chamber 35, to which internal chamber the vacuum switch is connected, is higher than a pre-determined acceptable maximum pressure. The signal thus generated corresponds to a detected leakage of surrounding fluid into said secondary internal vacuum chamber 35.

It is preferred that the secondary internal vacuum chamber 35 is kept relatively small, since, in the case of a leakage, the pressure will be affected quicker and more distinctly in a chamber having a smaller volume, than in a chamber having a larger volume. Thereby, a pressure-change in secondary internal vacuum chamber 35 due to leakage of fluid through one of holes 3 into said chamber can more reliably be detected.

The inventive gripper 10 is suitable for handling of sheet-formed objects, such as sheets 100, especially sheets having a sensitive portion 70. The sensitive portion 70 of an object 100 may e.g. be a portion having a reduced thickness as compared to the thickness of the remaining portion of the object 100. As an example, reduced thicknesses within the range of about 5-15 μm have been handled successfully with the inventive gripper. The inventive gripper is especially suitable for use in stacking sheets on top of each other, preferably in an automated process. The sheets could for example form part of an electrode, electrode assembly, membrane electrode assembly.

Other examples of sheet-formed objects 100 that could be handled by the inventive gripper are electrical insulating films or foils, such as battery insulation films, carbon fibre sheet, silicon wafers or sheets, such as wafers for solar panels, and thin labels.

The sheet-formed objects 100 are typically flexible.

The sheet-formed objects 100 may typically have a thickness of up to 2 mm, and preferably of 1 mm or less, such as e.g. 5 μm to 500 μm.

The sheet-formed objects 100 can be made of a polymeric material, such as plastic or rubber, or a metallic material, or a combination thereof.

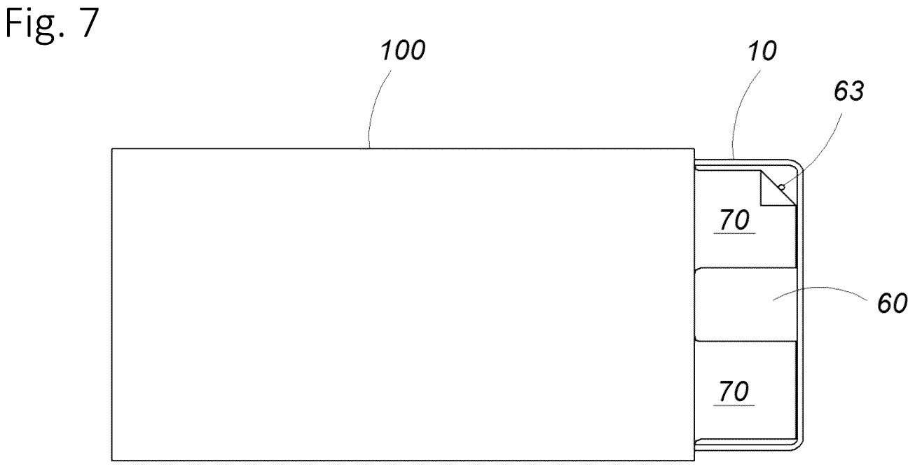

When a too high pressure is detected in a secondary internal vacuum chamber 35, e.g. in an automated operation, this may typically be due to that a sensitive portion 70 of a sheet-formed object 100 not being correctly aligned with a suction area A2 of the gripper, and/or there being a creasing or folding present in a sensitive portion 70 of a sheet-formed object 100 currently engaged with the gripper, or, a part, such as a corner, of a sensitive portion 70 could be flexed during handling of the object 100, such as by the relative action of surrounding fluid, typically ambient air, during movement of the object 100 through the surrounding fluid, so that one or more holes 3 in a suction surface A2 are no longer covered by the sensitive portion 70, such as shown in FIG. 7. Upon detection of a too high pressure in a secondary internal vacuum chamber 35, the automated operation is preferably stopped. When the automated operation has been stopped, an operator can conveniently remove the non-correctly aligned, creased, folded, or otherwise faulty sheet, and thereafter re-start or continue the automated process.

### LIST OF REFERENCE SIGNS USED

10 vacuum gripper
100 sheet-formed object to be engaged
20 vacuum gripper body
25 internal primary vacuum chamber
15 opening for connecting the primary vacuum chamber to vacuum
17 source of vacuum
30 opening for connection to a pressure sensor
33 pressure sensor
A2 suction area of secondary internal vacuum chamber
A1 suction area of primary vacuum chamber
3 suction hole
35 secondary internal vacuum chamber
37 flow-restriction
38 flow passage
39 opening in suction area to flow passage
50 compressible foam sheet
53 one or more holes (in foam sheet 50)
60 stiffening sheet
63 one or more holes (in stiffening sheet 60)
65 non-permeable backing
70 sensitive portion of sheet-formed object 100

1. A vacuum gripper (10) for gripping sheet-formed objects (100), comprising a body (20) having:
an internal primary vacuum chamber (25);
an opening (15) for connecting the primary vacuum chamber (25) to a source of vacuum (17);
an opening (30) for connection to a pressure sensor (33) configured to sensing a pressure inside the gripper body;
a suction area (A2, A1) for engaging a sheet-formed object (100);
at least one suction hole (3) provided in the suction area (A1, A2);
characterized in that
the body (20) additionally comprises a secondary internal vacuum chamber (35) which stands in fluid communication with the primary vacuum chamber (25) via a flow-restriction (37), and in that said at least one suction hole (3) is provided in a suction area (A2) of the secondary internal vacuum chamber (35),
wherein the size of the cross-sectional area of the flow restriction (37) is similar to the size of the cross-sectional area of one hole of the at least one hole (3), and the opening (30) for connection to a pressure sensor (33) is provided in the secondary internal vacuum chamber (35).

2. The vacuum gripper (10) of claim 1, wherein the size of the cross-sectional area of the flow restriction (37) is equal to, or smaller than the size of the cross-sectional area of one hole of the at least one hole (3).

3. The vacuum gripper (10) of claim 1, wherein the source of vacuum (17) is an ejector, preferably being attached to the gripper body (20).

4. The vacuum gripper (10) of claim 1, exhibiting a flow passage (38) which stands in fluid communication with the secondary internal vacuum chamber (35) and with the primary vacuum chamber (25), said flow passage having two openings (39) provided in the surface of the suction areas (Al and A2), respectively, which flow passage (38) is capable of forming a flow restriction (37) upon sealing of the openings (39) and of flow passage (38).

5. The vacuum gripper (10) of claim 1, additionally comprising a compressible foam sheet (50) essentially covering the suction area (A1, A2).

6. The vacuum gripper (10) of claim 5, wherein said compressible foam sheet (50) exhibits one or more holes (53) corresponding to one or more holes (3) of the suction area (A2) of the secondary internal vacuum chamber (35), preferably the foam sheet (50) is attached to the suction area (A1, A2) by means of adhesive so as to be replaceable.

7. The vacuum gripper (10) of claim 5, additionally comprising a stiffening sheet (60), essentially covering the foam sheet (50), exhibiting one or more holes (63) corresponding to holes (3) of the suction area (A2) of the secondary internal vacuum chamber (35), preferably the stiffening sheet is attached to the foam sheet (50) by means of adhesive so as to be replaceable.

8. The vacuum gripper (10) of claim 5, wherein the porous foam sheet (50) exhibits an adhesive non-permeable backing (65) for covering and sealing off desired suction holes (3) and/or an opening (39).

9. The vacuum gripper (10) of claim 1, wherein the suction area (A1) of the primary vacuum chamber (25) exhibits a multitude of suction holes (3), preferably said holes are evenly distributed over the suction area (A1) of the primary vacuum chamber (25).

10. The vacuum gripper (10) of claim 1, wherein the suction area (A2) of the secondary internal vacuum chamber (35) exhibits a multitude of suction holes (3), preferably said holes are evenly distributed over the suction area (A2) of the secondary internal vacuum chamber (35).

11. The vacuum gripper (10) of claim 10, wherein the size of the cross-sectional area of the flow restriction (37) is equal to, or smaller than the size of the cross-sectional area of the smallest hole (3) of the multitude of suction holes (3) distributed over the suction area (A2) of the secondary internal vacuum chamber (35).

12. The vacuum gripper (10) of claim 1, comprising one or more additional secondary internal vacuum chamber (35) each of which is connected to the primary vacuum chamber (25) via a flow-restriction (37), and each of which exhibits a suction area (A2) having at least one suction hole (3), wherein the cross-sectional area of the flow restriction (37) corresponds to that of one hole (3) of the at least one hole (3) provided in the respective suction area (A2).

13. A method of detecting leakage of surrounding fluid into a vacuum gripper (10) for gripping sheet-formed objects (100), comprising the steps of:
engaging a sheet-formed object (100) with a vacuum gripper (10);
while the sheet-formed object (100) is engaged with the vacuum gripper (10), monitoring a pressure in an internal vacuum chamber (35) of the gripper (10) using a pressure sensor (33) connected to said internal vacuum chamber (35);
comparing the monitored pressure with a pre-determined desired pressure; and,
establishing a monitored pressure which is higher than a pre-determined acceptable maximum pressure, characterized in that the gripper (10) comprises a primary internal vacuum chamber (25), and a secondary internal vacuum chamber (35), which chambers are fluidly connected to each other via a flow-restriction (37), and in that the pressure which is monitored is the pressure in the secondary internal vacuum chamber (35).

14. The method of claim 13, wherein the method is discontinued when a monitored pressure in the secondary internal vacuum (35) of the gripper (10) is established to be higher than the pre-determined acceptable maximum pressure.

15. Use of the gripper of claim 1 in a stacking operation for stacking a number of sheets (100) on top of each other, which stacking operation preferably is automated.
